(19) United States
(12) Patent Application Publication
(10) Pub. No.: US 2024/0132749 A1
(43) Pub. Date: Apr. 25, 2024

(54) URETHANE ALKYD RESIN

(71) Applicant: Asian Paints LTD., Mumbai (IN)

(72) Inventors: Rajeev K. JAIN, Navi Mumbai (IN); Devchandra PANDIT, Navi Mumbai (IN); Ganesh BATHIRI, Navi Mumbai (IN); Sagar PANGAM, Navi Mumbai (IN); Satishchandra SHETTY, Navi Mumbai (IN); Rajeev Kumar GOEL, Navi Mumbai (IN)

(73) Assignee: Asian Paints LTD., Mumbai (IN)

(21) Appl. No.: 18/402,719

(22) Filed: Jan. 2, 2024

Related U.S. Application Data
(63) Continuation-in-part of application No. 16/473,243, filed on Jun. 24, 2019, now abandoned.

(30) Foreign Application Priority Data
Nov. 27, 2017 (IN) 201721042425

(51) Int. Cl. C09D 175/06; C08G 18/46; C09D 5/10; C09D 7/61; C09D 7/80

(52) U.S. Cl. CPC C09D 175/06; C08G 18/4692; C09D 5/10; C09D 7/61; C09D 7/80; C08G 2150/90

(57) ABSTRACT

A formulation and process of preparing a functionalized-urethane alkyd resin, and a siliconized-urethane alkyd resin, is obtained from an alkyd based on semi drying/drying oils, or their fatty acids, having high iodine number of 120-170 (gm I₂/100 gm), followed by grafting of epoxy-alkyl-alkoxy silane or silanol-functional silicone resin into an alkyd backbone. There is also subsequent urethanization of the organosilane grafted alkyd. Siliconized-urethane alkyd thus obtained were incorporated in solvent-borne pigmented-coating compositions and found suitable for preparing air drying 1 pack coatings providing excellent corrosion resistance, weathering and mechanical properties when applied on variety of substrates such as mild steel, corroded mild steel, other metals, alloys, glass, wood and cementitious materials

### CROSS-REFERENCE TO RELATED APPLICATIONS

The present application is a continuation-in-part of U.S. patent application Ser. No. 16/473,243, filed Jun. 24, 2019, which application claims priority under 35 U.S.C. § 371 to PCT Patent Application Serial No. PCT/IN2018/050766, filed Nov. 20, 2018, which application claims the benefit of Indian Patent App. No. IN201721042425, filed Nov. 27, 2017, all of which are incorporated herein by reference in their entirety.

### FIELD OF THE INVENTION

The present invention relates to the formulation and process of silicone-functionalized-urethane alkyds obtained from alkyds, or fatty acids of alkyds. If fatty acids of alkyds are used, they must have an Iodine Number of 120-170 (gm I₂/100 gm), with linolenic acid content preferably <10%. There must also be present a subsequent reaction product of residual carboxylic and hydroxyl groups with epoxide-functional-alkoxy silane and/or with silanol-functional-silicone resins that are further reacted with aliphatic/cycloaliphatic/aromatic polyisocyanates or their derivatives to create urethane linkages. In another aspect of the present invention, the entire reaction of: (i) preparing a base alkyd; (ii) followed by grafting an epoxy=alkyl-alkoxy silane and/or a silanol-functional-silicone resin; and (iii) subsequent urethanization, is carried out in-situ.

In an embodiment of the present invention, such grafting of epoxy alkyl-alkoxy silane/silicone resin into an alkyd backbone, followed by adding a urethane, resulted in outstanding corrosion resistance and weathering performance. In light of these findings, such silicone functionalized alkyds have been found suitable for preparing air drying single component coating compositions for new, as well as corroded, mild steel and other metallic/nonmetallic substrates, when incorporated in solvent borne pigmented coating compositions. The single-pack coating compositions prepared from siliconized-urethane alkyd provide superior corrosion resistance, weathering and mechanical properties over conventional alkyds, or urethane alkyds free from such modification.

### BACKGROUND OF THE INVENTION

Alkyd-based single-component air-drying coatings are known for bottom of the pyramid economical paints and provide limited corrosion resistance and weathering performance. The present invention overcomes these limitations through a uniquely-designed silicone-functionalized-urethane-alkyd resin that provides superior performance characteristics, such as improved corrosion resistance, weathering, and mechanical properties, when incorporated in a suitably-designed, pigmented-coating composition.

Amongst various performance expectations from a coating, protection against corrosion of mild steel is of major commercial significance considering huge losses of steel are incurred due to corrosion, resulting in the weakening of the structures requiring replacement and repair. Thus, efforts to develop more efficient and environmentally compliant methods to prevent corrosion have been ongoing across the globe.

There are anti-corrosive paints available in the market based on epoxy, polyurethane, organic or inorganic zinc-rich coatings, etc., largely for industrial use. These coating compositions are mostly 2K systems that require measured quantities of the components to be mixed prior to use and employ hazardous aggressive solvents. Limited pot life and difficulty cleaning the coating equipment after the job is another hassle in two component coating systems. Such coating systems generally require multiple coating layers to be deposited to achieve desired overall high dry film thickness necessary for barrier protection. It is not feasible for a wider cross-section of domestic users to apply such a coating system.

Considering single component oxidative crosslinking, high renewable content and possibility to employ environmentally safer Mineral Turpentine Oil as solvent, it was decided to build desired aesthetics and high weathering and corrosion resistance performance in an alkyd coating by suitably reinforcing alkyd resin backbone.

In light of the present invention, some of the prior-art dealing with silicone and urethane modifications of alkyd resins, as well as their use in coatings, including in self-priming coating compositions, are described herein:

PCT Application No. WO2008/148716 titled “Polysiloxane and urethane modified water-reducible alkyd resins” discloses urethane and siloxane modified water-reducible alkyd resins, which form the two most essential embodiments of the invention. Further, claim 1 of the aforesaid invention claims polyhydric alcohols, modified fatty acids made by grafting olefinically unsaturated carboxylic acids onto fatty acids, ungrafted fatty acids, silanol or alkoxysilyl functional siloxane oligomers or polymers, and polyfunctional isocyanates.

European Application No. EP2155801 entitled “Polysiloxane and urethane modified water-reducible alkyd resins” also discloses a process for the synthesis of siloxane and urethane-modified water-reducible alkyd resins.

U.S. Application No. 2016/0244615 entitled “Metal effect pigments modified with a silane layer containing at least two different bifunctional silanes” discloses use of certain metals along with silanes.

U.S. Pat. No. 3,627,722 entitled “Polyurethane sealant containing trialkyloxysilane end groups” discloses presence of silane groups present at the ends of the polyurethane polymer chains.

U.S. Application No. 2005637813 entitled “Silanol-containing urethane dispersions” discloses poly(urethane-urea) terminated by hydrolyzable or hydrolyzed silyl groups.

European Application No. EP0967235 titled “Silicon-modified resins based on recurring units derived from allyl alcohol and their use in weather-resistant coatings” discloses silicon-modified alkyd resins. The process comprises reacting: A) at least one organosilicon compound B) at least one resin obtainable by reacting at least one fatty acid agent with at least one polyhydric polymer having an average OH functionality of about 2 to 25.

Chinese Patent No. CN 102134441 to Chen Yun et al. and entitled “Organic silicon Polyurethane composite modified alkyd resin coating composition and preparation method thereof” discloses a silicone-modified alkyd resin composite polyurethane coating compositions and methods of preparation. The two-component coating compositions comprising of modified active polysiloxane in component A and alkyd resin, solvent, pigment, filler and additives in component B, The two are mixed together when in use. The coating composition of the invention provides good adhesion, resistance to salt spray, salt water, anti-aging and excellent overall performance for the heavy steel anti-corrosion coating protection.

U.S. Pat. No. 5,539,032 to Hegedus et al. and entitled “Corrosion Resistant Self-Priming alkyd top coats” discloses coatings comprising of high dosages of anticorrosive pigments like aluminum triphosphate, zinc benzoate and an alkaline earth metal phosphate using Silicone Alkyd co-polymer. The coating is recommended for pretreated and unprimed metal to be cured at ambient or elevated temperature. The specification describes corrosion resistance for periods ranging up to 500 hrs. in an SO2—Salt Fog test, and up to 1000 hrs. in that Salt Fog test for coatings applied at about 10 mils thickness, and preferably, for coatings applied at 1-3 mils.

U.S. Pat. No. 5,089,551 to Hegedus et al. and entitled “Corrosion Resistant Alkyd Coatings” describes corrosion-resistant coating suitable for metal/plastic substrates as a single coat providing high-gloss and good adhesion/flexibility. The coating comprises of a Silicone alkyd resin and corrosion inhibiting pigments consisting of zinc-barium phosphate, zinc molybdate and at least one zinc salt of a benzoic acid and an organic solvent.

European Patent No. EP1499690A1 and U.S. Pat. No. 7,208,537 B2, each to Bhattacharya and entitled “Self Priming chromate free Corrosion Resistant Coating composition and method” disclose self-priming rapid curing chromate free corrosion resistant coating composition based on a polyvinyl terpolymer and an alkyd resin with hydroxyl number of 80-200 along with mineral acid catalyst and one or more organic solvents and a drying agent. The composition can be applied as a clear coat or as a pigmented composition with addition of pigments on ferrous and non-ferrous metallic substrate and is particularly suitable for continuous coil coating lines for curing at high temp of 180-280° C. Being heat curing, this invention is not within the scope of the present invention.

U.S. Pat. No. 5,021,489 to Knight et al. and entitled “Corrosion inhibiting coating Composition” discloses corrosion inhibiting film forming compositions which displace moisture from the metal substrate. Such coating compositions include an acrylic resin, a silicone resin and a copolymer derived from silicone and alkyd resin. The oil soluble petroleum sulfonates along with alkyl ammonium phosphate has been used to inhibit corrosion of the metal substrate. The organic solvent used comprises of aromatic hydrocarbon, glycol ether and cellosolve acetate.

None of the prior-art makes an discloses the use or preparation of a silicone-functionalized, urethane-alkyd resin, and its subsequent use in solvent-borne, single-component, air-drying coating compositions that provide improved corrosion resistance, weathering and mechanical properties.

In addition to the above prior-art summaries, there are also conventional two-component epoxy and polyurethane systems that provide some corrosion-resistance performance. However, multi-component and multi-product systems are different from, and outside the scope of the present invention.

### OBJECTS OF THE INVENTION

An object of the present invention is to design functionalized alkyds suitable for glossy-weatherable, top-coat/self-priming anti-corrosive coatings to combine aesthetically pleasing coatings and corrosion protection in a single component ready-to-use paint without the need of a primer for new and old mild-steel structures.

Another object of the present invention is to propose functionalized-urethane alkyds or, more particularly, siliconized-urethane-alkyd resin for single-pack ready-to-use corrosion and weather resistant top coats/self-priming enamel/under coat/primer for maintenance of old mild steel structures which presently require extensive surface preparation and employ multi-product and multi-coat systems such as 2K epoxy and polyurethanes. Use of such systems is quite cumbersome and not feasible for domestic users.

A further object of the present invention is to propose that the entire reaction of grafting epoxy-alkyl-alkoxy silane, or of forming a silanol-functional silicone resin, is followed by urethanization and is carried out in-situ.

Yet another object of the present invention is to propose the use of an epoxy-alkyl-alkoxy silane as a coupling agent, and as an adhesion promoter in a paint composition that has been pre-reacted into an alkyd backbone, enabling better utilization of functionalities and enhanced corrosion resistance performance. An effect of this proposal is to eliminate the need for an epoxy-alkyl-alkoxy silane in a coating composition.

Still another object of the present invention is to propose grafting of epoxy-alkyl-alkoxy silane into an alkyd backbone, followed by the addition of a urethane, resulted in improved weathering and corrosion resistant performance, which has not been obtained/reported from conventional alkyds or urethane alkyds free from such grafting and addition of urethane.

Still another object of the present invention is to propose that a functionalized-urethane alkyd has been designed to ensure improved solubility in commonly used mineral turpentine oil which is a mix of aliphatic/aromatic hydrocarbons, and safer for domestic painting purposes.

Yet another object of present invention is to propose that superior drying and hardness was facilitated using a unique combination of metallic driers providing faster recoat ability, leading to significant reduction in recoat time of 4-8 hours in comparison to >8 hours of conventional alkyds. This significantly reduced the time for completing painting activity.

A further object of the present invention is to propose that vegetable oil fatty acids, being a major ingredient, have been selected in a manner providing high unsaturation for excellent drying performance, while keeping linolenic acid content responsible for yellowing in a coating to preferably <10% but not limiting to if non-yellowing performance is not of a prime concern.

Still a further object of the present invention is to provide a process for the synthesis of base alkyd resin followed by grafting of epoxy-alkyl-alkoxy silane or organosilanes into alkyd backbone, which is further reacted with polyisocyanate to partially convert free hydroxyls into urethane linkages resulting into silicone functional urethane alkyds.

Yet another object of the present invention, apart from gloss and color retention, the said functionalized-urethane alkyd based top coat/self-priming enamel provides excellent corrosion protection to mild steel in different geographical and climatic conditions, including highly aggressive coastal environments. The coatings designed thereof would also provide protection to old corroded mild steel substrates after proper cleaning through hand tools like wire brush and sand paper, etc.

Another object of the present invention is to propose that such functionalized-urethane alkyd resin, when employed in paint recipe incorporating corrosion inhibiting pigment and additives known in the art, provided superior gloss, corrosion resistance, mechanical properties and weathering performance, especially in respect of gloss/non-yellowing.

### SUMMARY OF THE INVENTION

This invention relates to a siliconized-urethane alkyd resin composition comprising:
a base alkyd resin component having hydroxyl number in the range of 50-150 mg KOH/gm, and acid number of 6-10 mg KOH/gm; a reaction product of reactive sub-components selected from the groups consisting of polyhydric alcohols, polybasic carboxylic acids and anhydrides thereof, hydroxycarboxylic acids, monofunctional carboxylic acids and vegetable oils or their fatty acids;
an epoxy-alkyl-alkoxy silane organosilane component comprising one or more epoxy silanes or organosilanes having epoxide functional group selected from one or more of the groups consisting of epoxides, alkoxy silanes and silanols; and
an isocyanate component comprising one or more aliphatic, cycloaliphatic and aromatic isocyanate compounds having isocyanate functionality of 1 or more, wherein the isocyanate component consumes 40 to 70% of the initial OH number of the above component.

The present invention relates to a functionalized-urethane alkyd, or more particularly, siliconized-urethane alkyd resin for single-pack ready-to-use corrosion and weather resistant coatings/self-priming enamel for maintenance of new and old mild steel structures/objects which presently require extensive surface preparation and employ multi-product and multi-coat systems such as 2K epoxy and polyurethanes. Use of such systems is quite cumbersome and not feasible for domestic users.

Presently, there is no paint reported based on single component air drying siliconized-urethane alkyd chemistry which provides the attributes of self-priming, high gloss, fast drying, non-yellowing and excellent weathering resistance and corrosion resistance as per Salt Fog resistance of 1000 hours or more when applied in 3 or more coats at an interval of minimum 4-8 hours at a total dry film thickness (DFT) of 75-90 microns.

The present invention also relates to the synthesis of functionalized alkyd obtained from an alkyd based on drying and semi drying oils or their fatty acids having high iodine number of 120-170 (gm I₂/100 gm) with linolenic acid content preferably <10% but not limited to for achieving outstanding corrosion resistance and weathering performance in respect of gloss retention and non-yellowing. At the end of alkyd preparation, residual carboxylic acid and hydroxyl groups present in such alkyd are reacted with epoxy-alkyl-alkoxy silane and/or silanol functional silicone resin and siliconized alkyd thus obtained is further reacted with aliphatic/cycloaliphatic/aromatic polyisocyanates or their derivates to create urethane linkages.

Advantageously the entire process of said silicone functionalized-urethane alkyd involves following in-situ steps:

Base Alkyd having an average molecular weight of 4000-8000 through Gel permeation chromatography (GPC) was obtained from the reaction of Polyhydric alcohols, Poly functional carboxylic acids/anhydrides and monofunctional carboxylic acids in combination with drying and semi drying oils/fatty acids such as Dehydrated Castor Oil fatty acid, Sunflower fatty acid, soya bean oil fatty acid, Safflower fatty acid and linseed oil fatty acids or similar having iodine number of 120-170 (gm I₂/100 gm). The alkyd was processed at 170-250° C. till an acid number of 6-10 mg KOH/gm is achieved. The resultant alkyd has hydroxyl number of 50-150 mg KOH/gm and preferably 75-125 mg KOH/gm.

Alkyd resin thus obtained was further grafted with epoxide functional silicone such as [3-(2,3-Epoxypropoxy)propyl]trimethoxysilane], [3,4-epoxycyclohexyl trimethoxy silane] suitable to react with free carboxylic and hydroxyl functionality of alkyds at dosage of 0.5-5% of base alkyd resin at 130-220° C. till an acid number of 1-5 is achieved. Here free carboxylic group of alkyd resin reacts with oxirane ring of said epoxy-alkyl-alkoxy silane while alkoxy silane hydrolyzes forming silanol which undergoes condensation providing siloxane bond. Silanol reacts with hydroxyl functionality of alkyd resulting in silicone grafted alkyd. An average molecular weight of such silicone grafted functionalized alkyd ranges from 8000-12000 through GPC depending on the quantity and type of epoxy silane.

Siliconized alkyd resin as obtained above is further reacted with optimized dosages of Aliphatic/Cycloaliphatic/Aromatic Polyisocyanates or their derivatives to introduce urethane linkages to get siliconized-urethane alkyd having an average molecular weight of 20000-35000 through GPC depending on the type and extent of urethane modification.

Further, it is observed that the molecular weight of the components keeps increasing with further reaction and polymerization. In particular, due to subsequent reaction and polymerization of base alkyd to form Siliconized alkyd resin, the molecular weight (MW 4000-8000) of base alkyd resin increases. The molecular weight of siliconized alkyd is 8000-12000. The molecular weight of siliconized alkyd is basically dependent on the extent/type of silicone grafting in base alkyd. The molecular weight of siliconized-urethane is 20000-35000. The increase in the molecular weight is basically dependent on the extent/type of polyisocyanate reacted with siliconized alkyd.

Importantly, in another aspect of the present invention, incorporation of epoxy-alkyl-alkoxy silane into the alkyd backbone could be achieved due to the termination of alkyd synthesis at an acid number of 6-10 (mg KOH/gm) as well as conducting reaction at optimized temperature/time necessary to obtain the silicone grafted alkyd suitable for further reaction with polyisocyanate avoiding premature gelation.

According to another aspect of the present invention, the said silicone functionalized-urethane alkyd has been designed to ensure excellent solubility in commonly used mineral turpentine oil (MTO) which is a mix of aliphatic/aromatic hydrocarbons and preferred choice for domestic painting applications owing to various advantages offered by such solvent including excellent recoat ability, low odor, higher flash point and low cost.

In one of the embodiments of the present invention, superior drying and hardness was also facilitated using an unconventional combination of metallic driers i.e. octoates/naphthenates of cobalt, zirconium, calcium and iron complex enabling recoat time of 4-8 hours in comparison to >8 hours of conventional urethane alkyds. This significantly reduces the cycle time for completing the painting activity.

It is a finding of the present invention that such silicone functionalized-urethane alkyd resin when used in paint recipe incorporating organic pigment, inorganic pigment, corrosion inhibiting pigment and additives known in the art provide good gloss, corrosion resistance, mechanical properties and weathering performance especially in respect of gloss retention/non-yellowing.

Surprisingly, the siliconized-urethane alkyd as stated above provided outstanding corrosion resistance on new, as well as corroded, mild steel and other metallic substrates when suitably formulated in pigmented coating compositions comprising of inorganic/organic pigments, anticorrosive pigments, dispersing agents, metallic driers, UV light absorbers, hindered amine light stabilizers, anti-skin agent, flow and levelling additives and solvents. Preferred dry film thickness of the coating for achieving optimum performance properties is 75-90 microns in 3 coats while ensuring a time interval of 4-8 hours between the coats.

### DETAILED DESCRIPTION OF THE INVENTION

The present invention can be characterized as the formulation and process of silicon-functionalized-urethane alkyd resins and their use in air-drying top coatVself-priming enamel/under-coat/primer, providing improved corrosion- and weathering-performance when incorporated in suitably designed pigmented-coating compositions.

The present invention is primarily directed to metal as a top coat/self-priming glossy coating composition comprising of said siliconized-urethane alkyd, organic/inorganics pigments including anti-corrosive pigments, metallic driers, UV light absorbers, hindered amine light stabilizers, anti-skin agent, solvent and additives for decorative, general industrial and auto refinish application. However, the coating designed thereof would also find suitability to decorate and protect other substrates as well like wood, glass and masonry etc.

One of the principle aspects of the present invention relates to the development of a polymeric binder for corrosion resistant and weatherable coatings and composition of the same according to the invention is being described here in detail.

The present invention deals with a silicon-functionalized-urethane alkyd obtained from alkyd based on drying/semidrying oils, or their fatty acids, having an Iodine Number of 120-170 (gm I₂/100 gm) with linolenic acid content preferably <10%. That alkyd should include a subsequent reaction of residual carboxylic and hydroxyl groups present in such alkyd with epox-functional-alkoxy silane and/or with silanol-functional silicone resins which are further reacted with aliphatic, cycloaliphatic and aromatic polyisocyanates or their derivatives to impart urethane linkages.

Reaction of epoxy-alkyl-alkoxy silane and/or silanol functional silicone resins into the alkyd backbone facilitates improved adhesion, heat and UV resistance due to the formation of stable covalent bonds of M—O—SI (M═Fe, Al, Si) and an interpenetrating polymer network. Grafting with epoxy-alkyl-alkoxy silane facilitates the reaction of oxirane group with the residual carboxylic functionality available in the alkyd, which otherwise remains unutilized when epoxy-alkyl-alkoxy silane is used as an additive coupling agent in the coating composition. Even hydrolysis of epoxy-alkyl-alkoxy silane necessary to impart desired effect in a crosslinked pigmented coating matrix would be gradual at ambient temperature.

Through their dual reactivity, organosilanes act as bridge between inorganic substrates and polymer matrices. In view of this chemical grafting of epoxy-alkyl-alkoxy silane at elevated temperature into an alkyd backbone, followed by urethanization, provides paints with improved adhesion- and corrosion-resistance, and improved weathering performance over conventional paint with a urethane alkyd that has not been prepared according to the description above.

Advantageously, in another aspect of the present invention, the entire reaction of preparing a base alkyd, followed by grafting epoxy-alkyl-alkoxy silane and/or silanol functional silicone resin, and performing subsequent urethanization, is carried out in-situ.

In one aspect of the present invention, the silicone functionalized-urethane alkyd has been designed to obtain improved solubility in commonly used mineral turpentine oil which is a mix of aliphatic/aromatic hydrocarbons and preferred choice for domestic painting use over other organic solvents considering strong smell, low flash points and hazards associated with them in addition to the high costs. Use of mineral turpentine oil also offers improved recoat ability and overall economy to the coating recipe.

The alkyd resin used in the present invention was obtained from semi drying/drying oils or their fatty acids, polyhydric alcohols, polybasic carboxylic acid or their anhydrides and monocarboxylic acids. The base alkyd was designed to have free OH functionality with hydroxyl number of 50-150 mg KOH/gm and processed to an acid number of 6-10 mg KOH/gm required for further reaction with organosilanes and polyisocyanates.

The vegetable oils and their fatty acids used for base alkyd of the present invention include soy bean oil, sunflower oil, dehydrated castor oil, safflower oil, tobacco seed oil, tung oil, or a mixture thereof, preferably having linolenic acid content of <10%. However, the invention includes other oil/fatty acids having higher linolenic acid content such as linseed oil, rubber seed oil, niger seed oil, perilla oil, hemp seed oil, tall oil, or a customized-mixture thereof, commercially available under different brands from commercially available suppliers if non-yellowing performance of the final alkyd is not of primary concern. Vegetable oil fatty acids have been preferred in the present invention to achieve improved color and drying of the siliconized-urethane alkyds. The amount of such oils or fatty acids may vary from 25-80% of resin solids and more preferably 40-70%.

The polyols/polyhydric alcohols suitable for the practice of the present invention having two or more hydroxyl groups per molecule. There are many polyols known in the art, or mixtures thereof, such as trimethyl pentanediol, diethylene glycol, neopentyl glycol, glycerol, pentaerythritol, trimethylolethane, trimethylol propane, methane propane diol, butyl ethyl propane diol, cyclohexane dimethylol; 1,6 hexane diol; 1,4 butane diol, sorbitol, hydroxypivalic acid neopentyl glycol ester, or a mixture thereof. This also includes use of dual-functional monomers in the alkyd backbone having carboxylic and hydroxyl functionality like dimethylol propionic acid or epoxy functional monomer and polymers which may create OH functionality during reaction. The amount of such polyols or dual functional monomers would vary from 8-35% and more preferably 12-30% based on alkyd resin solids.

The polybasic acids or acid anhydrides suitable towards the synthesis of base alkyd of the present invention include isophthalic acid, terephthalic acid, phthalic anhydride, trimellitic anhydride; 1, 4 cyclohexane dicarboxylic acid; 1,2 cyclohexane dicarboxylic acid anhydride, maleopimaric acid, Dimer fatty acid as well as other aromatic or cycloaliphatic acid anhydride as such or in combination thereof.

However, the preferred ones are phthalic anhydride and isophthalic acid. The amount of aromatic dicarboxylic acid would vary depending on the oil length of base alkyd and extent of intended grafting of epoxy-alkyl-alkoxy silane or organosilanes and subsequent reaction with polyisocyanates. The amount of polybasic acids or their anhydride may vary form 8-35% and more preferably 12-30% based on alkyd resin solids. In the present invention Phthalic anhydride has been preferred over other carboxylic acids/anhydrides to make the resin commercially viable.

Suitable mono functional carboxylic acids for the present invention include benzoic acid, tertiary butyl benzoic acid, abietic acid (Rosin) and cyclohexane carboxylic acid as chain terminator, but preferred one is benzoic acid. The amount of aromatic carboxylic acid can vary from 0-15% and preferably 0-8% based on total ingredients of base alkyd.

The esterification catalyst suitable for the synthesis of base alkyd of the present invention include dibutyl tin oxide, Lithium hydroxide, Lithium salts of fatty acids/carboxylic acids and metal salts or their oxides known for esterification and transesterification. However, such catalyst would necessarily be required for oil-based alkyd synthesis requiring monoglyceride formation but alkyd synthesis starting from oil fatty acid may also be carried out in the absence of such catalysts with a little longer esterification/polymerization time.

Preferred Reflux solvent employed for the base alkyd preparation was O-xylene or its isomers to the extent of 1-7% and more preferably 3-5%. However, other solvent like methyl n-amyl ketone may be used wherever nonaromatic solvent is the preferred choice.

In the second step of the reaction, epoxy-alkyl-alkoxy silane or organosilanes suitable for incorporation into the alkyd backbone include [3-(2,3-Epoxypropoxy)propyl]trimethoxysilane], [3,4 epoxycyclohexyl trimethoxy silane] or similar functional silane or silanol functional resin intermediates suitable to react with carboxylic and hydroxyl functional base alkyd resin at 130-220° C. till an acid number of 1-5 is achieved. Here preferred dosage of such organosilane incorporation in respect of epoxy-alkyl-alkoxy silane is 0.5-5% and more preferably 0.5-3% based on alkyd resin solids whereas preferred organosilane incorporation in respect of silanol functional silicone resin intermediates varies from 2.0-20% and more preferably 2-10%.

In the third and final step of forming siliconized-urethane alkyd, silicone grafted alkyd prepared in second stage is reacted with an aliphatic, cycloaliphatic or aromatic polyisocyanate or their derivatives. In the present invention cycloaliphatic polyisocyanate i.e Isophorone diisocyanate (IPDI) has been preferred over aromatic diisocyanate like toluene diisocyanate for superior weathering performance especially in respect of gloss and non-yellowing. For the purpose of present invention, amount of IPDI may vary from 1-10% on siliconized alkyd solids and more preferably 2-5%.

The catalyst used for the reaction of free hydroxyls with polyisocyanate include compounds of metal salts or esters of tin, Zinc, Zirconium etc. such as dibutyl tin dilaurate, zinc octoate, zirconium octoate etc. at effectively low metal contents to facilitate faster reaction especially with less reactive aliphatic or cycloaliphatic polyisocyanates.

The siliconized-urethane alkyd involving aforesaid formulation and process steps may be produced at up to 90% nonvolatile content and more preferably up to a nonvolatile content of 75%. The viscosity of such siliconized-urethane would entirely depend on various factors such as composition of base alkyd, extent of epoxy-alkyl-alkoxy silane or organosilanes grafting, extent of polyisocyanate modification including process control at various stages of preparation.

The following examples illustrate certain embodiments and aspects of the present invention and are not to be construed as limiting the scope thereof. All parts and percentages are by weight basis unless otherwise stated.

### Example 1

A urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean oil Fatty acid | 25.74 |
| Phthalic anhydride | 11.00 |
| Pentaerythritol (Nitration grade) | 11.90 |
| Benzoic acid | 4.97 |
| Dibutyl Tin Oxide | 0.10 |
| O-Xylene | 4.15 |
| Toluene Diisocyanate | 2.47 |
| Mineral Turpentine Oil | 39.67 |
| Total | 100.00 |

Soy bean oil fatty acid, phthalic anhydride Pentaerythritol, benzoic acid, Dibutyl Tin Oxide and O-xylene as reflux solvent were charged into the aforesaid reaction assembly and reaction mass was slowly heated to a temperature of up to 230° C. under azeotropic distillation with removal of water of reaction periodically providing an alkyd having acid number of 7.24 mg KOH/g and dilution viscosity (25° C. on Gardner scale) at 55% NVM in mineral turpentine oil of U-V. Reaction mixture is cooled to 80-90° C. and further reacted with Toluene diisocyanate at 80-90° C. and maintained for 4-6 hours till constant viscosity is achieved. A clear Urethane alkyd solution is obtained with approx. 55% nonvolatile content, hydroxyl number (mg KOH/gm) 81.50, acid number 6.77 mg KOH/g and viscosity of Y-Z at 25° C. on Gardner scale. The resin was tested for accelerated stability at 55° C. for 15 days and no appreciable change in viscosity was observed.

The urethane alkyd resin thus obtained was used to prepare white paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### Example 2

A urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean oil Fatty acid | 25.87 |
| Phthalic anhydride | 10.79 |
| Pentaerythritol Nitration Grade | 11.69 |
| Benzoic acid | 4.88 |
| Dibutyl Tin Oxide | 0.10 |
| O-Xylene | 4.11 |
| Dibutyl Tin dilaurate | 0.05 |
| Isophorone Diisocyanate | 2.70 |
| Mineral Turpentine Oil | 39.81 |
| Total | 100.00 |

Soy bean oil fatty acid, phthalic anhydride Pentaerythritol, benzoic acid, Dibutyl Tin Oxide and O-xylene as reflux solvent were charged into the aforesaid reaction assembly and reaction mass was slowly heated to a temperature up to 230° C. under azeotropic distillation with removal of water of reaction periodically providing an alkyd having acid number of 6.85 mg KOH/g and viscosity (25° C. on Gardner scale) at 55% NVM in mineral turpentine oil of U-V. Reaction mixture is cooled to 80-90° C., added Dibutyl Tin dilaurate and further reacted with Isophorone Diisocyanate at 80-90° C. and maintained for 4-6 hours till constant viscosity is achieved. A clear urethane alkyd solution is obtained with approx. 55% nonvolatile content, hydroxyl number (mg KOH/gm) 78.10, acid number 6.24 mg KOH/g and viscosity of X-Y at 25° C. on Gardner scale. The resin was tested for accelerated stability at 55° C. for 15 days and no appreciable change in viscosity was observed.

The urethane alkyd resin thus obtained was used to prepare white paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### Example 3

A urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean oil Fatty acid | 31.75 |
| Phthalic anhydride | 13.56 |
| Pentaerythritol Nitration Grade | 11.34 |
| Trimethylol Propane | 1.89 |
| Benzoic acid | 1.66 |
| Dibutyl Tin Oxide | 0.10 |
| O-Xylene | 2.50 |
| Isophorone Diisocyanate | 1.47 |
| Mineral Turpentine Oil | 35.83 |
| Total | 100.00 |

Soy bean oil fatty acid, phthalic anhydride Pentaerythritol, Trimethylol propane, benzoic acid, Dibutyl Tin Oxide and O-xylene as reflux solvent were charged into the aforesaid reaction assembly and reaction mass was slowly heated to a temperature upto 230° C. under azeotropic distillation with removal of water of reaction periodically providing till an alkyd having acid number of 6.89 mg KOH/g and dilution viscosity (25° C. on Gardner scale) at 60% NVM in mineral turpentine oil of V-W. Once the desired constants are achieved, reaction mixture is cooled to 80-90° C. and further reacted with Isophorone Diisocyanate at 80-90° C. and maintained for 4-6 hours till constant viscosity is achieved. A clear Urethane alkyd solution is obtained with approx. 60% nonvolatile content, hydroxyl number (mg KOH/gm) 68.54, acid number of 6.34 mg KOH/g and viscosity of Y-Z at 25° C. on Gardner scale. The resin was tested for accelerated stability at 55° C. for 15 days and no appreciable change in viscosity was observed.

The urethane alkyd resin thus obtained was used to prepare white Paint at a PVC of 14-20% using titanium dioxide, zinc phosphate, dispersing agent, metallic driers, UV-light absorbers, hindered amine light stabilizers and flow-levelling additives. The resulting paint was tested for drying, physical, mechanical, weathering and corrosion resistance performance and test results are summarized in the table.

### Example 4

A urethane alkyd resin is prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Mixed Fatty acid (Iodine number 155 gm | 25.38 |
| I₂/100 gm & Linolenic acid content 22%) | |
| Phthalic anhydride | 10.86 |
| Pentaerythritol Nitration Grade | 11.77 |
| Trimethylol Propane | 1.89 |
| Benzoic acid | 4.92 |
| Dibutyl Tin Oxide | 0.10 |
| O-Xylene | 3.08 |
| Isophorone Diisocyanate | 3.00 |
| Mineral Turpentine Oil | 39.00 |
| Total | 100.00 |

Mixed fatty acid (Iodine number 155 gm I₂/100 gm & Linolenic acid content 22%), phthalic anhydride, Pentaerythritol, Trimethylol propane, benzoic acid and O-xylene as reflux solvent were charged into the aforesaid reaction assembly and reaction mass was slowly heated to a temperature upto 230° C. under azeotropic distillation with removal of water of reaction periodically providing an alkyd having acid number of 7.34 mg KOH/g and dilution viscosity (25° C. on Gardner scale) at 55% NVM in mineral turpentine oil of T-U. Once the desired constants are achieved, reaction mixture is cooled to 80-90° C. and further reacted with Isophorone Diisocyanate at 80-90° C. and maintained for 4-6 hours till constant viscosity is achieved. A clear Urethane alkyd solution is obtained with approx. 55% non-volatile content, hydroxyl number (mg KOH/gm) 125.30, acid number 6.44 and viscosity of Z-Z1 at 25° C. on Gardner scale. The resin was tested for accelerated stability at 55° C. for 15 days and no appreciable change in viscosity was observed.

The urethane alkyd resin thus obtained was used to prepare white paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### Example 5

A silicone-resin-grafted urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean oil Fatty acid | 25.00 |
| Phthalic anhydride | 11.00 |
| Pentaerythritol nitration grade | 11.64 |
| Benzoic acid | 5.00 |
| Dibutyl Tin Oxide | 0.10 |
| O-Xylene | 3.92 |
| Xiameter RSN Z 6018 | 2.08 |
| Dibutyl Tin dilaurate | 0.05 |
| Isophorone Diisocyanate | 3.21 |
| Mineral Turpentine Oil | 38.0 |
| Total | 100.00 |

Soy bean oil fatty acid, phthalic anhydride Pentaerythritol, benzoic acid and 0-xylene as reflux solvent were charged into the aforesaid reaction assembly and reaction mass was slowly heated to a temperature up to 230° C. under azeotropic distillation. Periodic removal of water from the reaction provided an alkyd having an acid number of 6.34 mg KOH/g, and a dilution viscosity (25° C. on Gardner scale) at 55% NVM in mineral turpentine oil of U-V. The reaction mixture was cooled to 180-190° C., and reacted with Xiameter RSN Z 6018 at batch temperature 180-210° C. for 2-3 hours, until it provided an acid number of 4.25 mg KOH/gm The reaction mass was further reacted with Isophorone Diisocyanate at 80-90° C. in presence of Dibutyl Tin dilaurate and maintained for 4-6 hours till constant viscosity is achieved. A clear siliconized-urethane alkyd solution is obtained with approx. 55% nonvolatile content, hydroxyl number (mg KOH/gm) 80.45, acid number 3.84 and viscosity of Z2-Z3 at 25° C. on Gardner scale. The resin was tested for accelerated stability at 55° C. for 15 days and no appreciable change in viscosity was observed.

The siliconized-urethane alkyd resin thus obtained was used to prepare white paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### Example 6

A silicone resin grafted urethane alkyd was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean oil Fatty acid | 25.00 |
| Phthalic anhydride | 11.00 |
| Pentaerythritol nitration grade | 11.64 |
| Benzoic acid | 5.00 |
| Dibutyl Tin Oxide | 0.10 |
| O-Xylene | 7.02 |
| Xiameter RSN Z 6018 | 2.08 |
| Dibutyl Tin dilaurate | 0.05 |
| Toluene Diisocyanate | 2.47 |
| Mineral Turpentine Oil | 35.64 |
| Total | 100.00 |

Soy bean oil fatty acid, phthalic anhydride Pentaerythritol, benzoic acid, Dibutyl Tin Oxide and O-xylene as reflux solvent were charged into the aforesaid reaction assembly and reaction mass was slowly heated to a temperature up to 230° C. under azeotropic distillation with removal of water of reaction periodically providing an alkyd having acid number of 6.35 mg KOH/g and dilution viscosity (25° C. on Gardner scale) at 55% NVM in mineral turpentine oil of V-W. Once the desired constants are achieved, reaction mixture is cooled to 180-190° C. and reacted with Xiameter RSN Z 6018 at batch temperature 180-210° C. for 2-3 hours providing siliconized alkyd having an acid number of 3.77 mg KOH/gm. The reaction mass was further reacted with Toluene Diisocyanate at 80-90° C. in presence of Dibutyl Tin dilaurate and maintained for 4-6 hours till constant viscosity is achieved.

A clear siliconized-urethane alkyd solution is obtained with approx. 55% nonvolatile content, hydroxyl number (mg KOH/gm) 79. 65, acid number 3.34 mg KOH/g and viscosity of Z1-Z2 at 25° C. on Gardner scale. The resin was tested for accelerated stability at 55° C. for 15 days and no appreciable change in viscosity was observed.

The siliconized-urethane alkyd resin thus obtained was used to prepare white paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### Example 7

A silicone functional urethane alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Soya bean Oil Fatty acid | 25.27 |
| Phthalic anhydride | 10.79 |
| Pentaerythritol Nitration Grade | 11.69 |
| Benzoic Acid | 4.88 |
| Dibutyl tin Oxide | 0.10 |
| O-Xylene | 4.11 |
| 3-(2,3-Epoxypropoxy)propyl] trimethoxysilane | 0.7 |
| Dibutyl Tin dilaurate | 0.05 |
| Isophorone Diisocyanate | 3.10 |
| Mineral Turpentine Oil | 39.31 |
| Total | 100.00 |

Soy bean oil fatty acid, phthalic anhydride, Pentaerythritol, benzoic acid, Dibutyl tin Oxide and O-xylene as reflux solvent were charged into the aforesaid reaction assembly and reaction mass was slowly heated to a temperature of up to 230° C. under azeotropic distillation with removal of water of reaction periodically providing till an alkyd having acid number of 7.09 mg KOH/g and dilution viscosity (25° C. on Gardner scale) at 55% NVM in mineral turpentine oil of T-U. Reaction mixture is cooled to 160-180° C. and reacted with 3-(2,3-Epoxypropoxy) propyl trimethoxysilane. Methanol and water produced during the reaction along with O-xylene were distilled off and reaction temperature was slowly raised to 200-220° C. and maintained for 2-3 hours providing siliconized alkyd having an acid number of 3.82 mg KOH/gm. The reaction mass was added with dibutyl tin dilaurate and further reacted with Isophorone Diisocyanate at 80-90° C. and maintained for 4-6 hours till constant viscosity is achieved. A clear silicone functional urethane alkyd solution is obtained with approx. 55% nonvolatile content, hydroxyl number (mg KOH/gm) 82.65, acid number 3.29 and viscosity of Z3-Z4 at 25° C. on Gardner scale. The resin was tested for accelerated stability at 55° C. for 15 days and no appreciable change in viscosity was observed.

The silicone-functional urethane-alkyd resin thus obtained was used to prepare white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table.

### Example 8

A silicone-functional urethane-alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Dehydrated Castor Oil Fatty acid | 27.19 |
| Phthalic anhydride | 9.74 |
| Pentaerythritol Nitration Grade | 12.36 |
| Benzoic acid | 4.41 |
| Dibutyl tin Oxide | 0.10 |
| O-Xylene | 7.82 |
| 3-(2,3-Epoxypropoxy) propyl trimethoxysilane | 1.08 |
| Dibutyl Tin dilaurate | 0.05 |
| Isophorone Diisocyanate | 2.00 |
| Mineral Turpentine Oil | 35.25 |
| Total | 100.00 |

Dehydrated castor oil, fatty acid, phthalic anhydride Pentaerythritol, benzoic acid, Dibutyl tin Oxide and O-xylene as reflux solvent were charged into the aforesaid reaction assembly and reaction mass was slowly heated to a temperature from 160° C. to 230° C. under azeotropic distillation with removal of water of reaction periodically providing an alkyd having acid number of 6.79 mg KOH/g and dilution viscosity (25° C. on Gardner scale) at 55% NVM in mineral turpentine oil of U-W. Reaction mixture is then cooled to 160-180° C. and reacted with 3-(2,3-Epoxypropoxy) propyl trimethoxysilane. Methanol and water produced during the reaction along with O-xylene were distilled off and reaction temperature was slowly raised to 200-220° C. and maintained for 2-3 hours providing siliconized alkyd having an acid number of 4.22 mg KOH/gm. The reaction mass was then further reacted with Isophorone Diisocyanate in presence of Dibutyl Tin dilaurate at 80-90° C. and maintained for 4-6 hours till constant viscosity is achieved. A clear silicone functional urethane alkyd solution is obtained with approx. 55% nonvolatile content, hydroxyl number (mg KOH/gm) 112.26, acid number 3.56 mg KOH/gm and viscosity of Z2-Z3 at 25° C. on Gardner scale. The resin was tested for accelerated stability at 55° C. for 15 days and no appreciable change in viscosity was observed.

The silicone-functional urethane-alkyd resin thus obtained was used to prepare white paint at a PVC of 14-20% using titanium dioxide, zinc phosphate, dispersing agent, metallic driers, UV-light absorbers, hindered amine light stabilizers and flow-levelling additives. The resulting paint was tested for drying, physical, mechanical, weathering and corrosion resistance performance and test results are summarized in the table.

### Example 9

A silicone-functional urethane-alkyd resin was prepared by charging the following constituents into a four-necked reactor flask equipped with a temperature controller, heating mantle, nitrogen purger, overhead stirrer and Dean Stark assembly.

| Ingredients | Parts by Weight |
|---|---|
| Safflower Fatty acid | 41.05 |
| Phthalic anhydride | 12.39 |
| Pentaerythritol Nitration Grade | 11.89 |
| Trimethylol Propane | 2.23 |
| Dibutyl tin Oxide | 0.10 |
| O-Xylene | 3.56 |
| 3-(2,3-Epoxypropoxy)propyl] trimethoxysilane | 1.30 |
| Dibutyl Tin dilaurate | 0.05 |
| Isophorone Diisocyanate | 2.38 |
| Mineral Turpentine Oil | 25.05 |
| Total | 100.00 |

Safflower fatty acid, phthalic anhydride Pentaerythritol, Trimethylol Propnane, Dibutyl tin Oxide and O-xylene as reflux solvent were charged into the aforesaid reaction assembly and reaction mass was slowly heated to a temperature of up to 230° C. under azeotropic distillation with removal of water of reaction periodically providing an alkyd having acid number of 6.68 mg KOH/g and dilution viscosity (25° C. on Gardner scale) at 65% NVM in mineral turpentine oil of V-W and an average molecular weight of 6015 using Gel permeation Chromatography (GPC). The reaction mixture was then cooled to 160-180° C. and reacted with 3-(2,3-Epoxypropoxy) propyl trimethoxysilane. Methanol and water produced during the reaction along with O-xylene were distilled off, the reaction temperature was slowly raised to 200-220° C., and maintained for 2-3 hours until it provided a siliconized-alkyd having an acid number of 3.69 mg KOH/gm and an average molecular of 10477 using GPC. The reaction mass was added with dibutyl tin dilaurate and further reacted with Isophorone Diisocyanate at 80-90° C. and maintained for 4-6 hours till constant viscosity is achieved. A clear silicone functional urethane alkyd solution is obtained with approx. 65% non-volatile content, hydroxyl number (mg KOH/gm) 79.44, acid number 3.11 mg KOH/g, viscosity of Z3-Z4 at 25° C. on Gardner scale and an average molecular weight of 29315 using GPC. The resin was tested for accelerated stability at 55° C. for 15 days and no appreciable change in viscosity was observed.

The silicone functional urethane alkyd resin thus obtained was used to prepare a white Paint at a PVC of 14-20% using Titanium dioxide, Zinc phosphate, dispersing agent, metallic driers, UV light absorbers, hindered amine light stabilizers and flow-levelling additives. The resulting paint was tested for drying, physical, mechanical, weathering and corrosion resistance performance and test results are summarized in the table. The details pertaining to Coating compositions obtained from examples 1-9 are being described here in detail: Coating Compositions Derived From Siliconized-Urethane Alkyd:

Corrosion is commonly defined as a chemical or electrochemical reaction between a material, usually a metal, and its environment that produces a deterioration of the metal and its properties. Corrosion may occur due to contact by atmospheric moisture, water, salinity, humidity or other corrosives normally present in rural, urban or industrial environments. Although coating composition of the present invention may be applied to any type of metallic substrate, it is especially suited for use on ferrous substrates. The present invention relates to the coating compositions for providing corrosion resistance to metallic objects/structures used in decorative as well as industrial segments.

In a special finding associated with the present invention, the suitably-designed, pigmented-coating compositions, when applied on mild steel substrate at a dry-film thickness of 75-90 microns, in three or more coats, with an interval of 4-8 hours between coats, provided corrosion resistance performance of 1000 hours or more without any sign of under-film corrosion. Surprisingly, the coating compositions based on the above-described silicone-functionalized-urethane alkyd also inhibited further corrosion when applied on properly cleaned corroded steel panels at dry film thickness of 75-90 microns in 3 or more coats for 800 hours or more as per ASTM B117 salt spray test.

The functionalized-urethane alkyd of the present invention provided high corrosion resistance and weathering performance while maintaining good gloss and mechanical properties like hardness, flexibility, impact and adhesion when used in a paint recipe involving organic/inorganic pigment, anticorrosive pigments, metallic driers, UV light absorbers, hindered amine light stabilizers and other additives known in the art as per details given below:

Pigments provide color, opacity, light fastness and barrier properties to the paint film. The most commonly used inorganic pigments are Titanium dioxide, carbon black, Iron oxides, zinc chromates, chromium oxides, cadmium sulphides, lithopone, etc. Amongst the organic pigments, important ones are Azo metal complexes, phthalocyanine and anthraquinone derivatives, benzimidazolone, quinacridone, dioxazine, perylene, thioindigo, diketopyrollopyrrole, etc.

In one of the embodiments of the present invention, the suitable anti-corrosive pigments include zinc phosphate, zinc oxide, calcium phosphate, strontium phosphosilicates, aluminium triphosphate, zinc molybdate, zinc phosphor molybdate, aluminium zinc phosphate, micaceous iron oxide, lead silico chromate, strontium chromate etc. and may form the part of coating composition in an amount of about 0.5 to 6% of the coating composition based on the total weight of the coating composition. Preferably, the anti-corrosive pigment content used was 0.5-3% based on the total weight of the coating composition. The higher quantities of anticorrosive pigments would improve corrosion resistance performance but significantly reduces the gloss. A preferred anti-corrosive pigment employed in the present coating composition is micronized zinc phosphate.

In one of the embodiments of present invention, metallic driers were employed to accelerate the conversion of coating into cross linked dry film through auto oxidative polymerization. Driers are primarily metal soaps of organic acids. Some of the preferred drier combinations employed with versions of the present invention are selected from the following group:
1) Cobalt Octoate: Acts as a “Surface Drier”. It is primarily an oxidation catalyst and an optimum quantity need to be used to avoid surface wrinkling
2) Borchi Oxy coat: It is a highly active Iron complex and recommended as an alternative to Cobalt based driers. However, in the present invention it has been used synergistically with cobalt to optimize cost and performance.
3) Calcium Octoate: It has both oxidizing and polymerizing properties and produce hard film.
4) Zirconium Octoate: Acts as an active cross-linking agent and improves hardness of dried film as well as its adhesions.

However, this invention is not limited to the aforesaid preferred metal salts and would also include all metal salts and their combination available under different trade names which could be used synergistically in the optimized ration to achieve desired coating performance.

In the paint compositions of the present invention, there may further be added various additives such as rheology modifiers, dispersing agent, antioxidants, anti-skinning and anti-settling agent etc. each in an adequate amount. A preferred solvent is MTO. The proportion of solvent may vary according to the desired consistency of the paint composition.

The present invention provides coating compositions which are meant for top coat/self-priming enamel/under coat/primer for various ferrous, non-ferrous and chemical treated substrates such as degreased, iron/zinc phosphated etc. and may be easily applied by conventional application systems such as brushing, roller, spraying, sprinkling, flow coating, dipping, and the like. The DFT of the coating is preferably 75-90 microns in 3 or more coats wherein time interval between coats is 4-8 hours.

According to a further aspect of the present invention, a test metal panel (cold-rolled mild steel) coated with a control composition and a composition as per the current invention were subjected to various tests after 7 days of application to evaluate the coated film in respect of flexibility, impact resistance, scratch hardness, 1 mm cross cut adhesion and resistance to salt spray and weathering. The flexibility of the coatings was tested by conducting a Mandrel bend test (ASTM D 522). Scratch hardness of the coating was tested using Sheen make automatic scratch tester Ref. No. 705 with 1 mm tungsten carbide tip. The 1 mm cross-cut adhesion test was carried out according to ASTM D 3359. Impact Resistance of coating was tested using Falling-Ball Method (65±0.2 cm height×15.9±0.08 mm diameter×908±1 gm load).

The salt-spray resistance of the coating was tested according to ASTM B117. The appearance of corrosion product was evaluated periodically, and test duration depended on the corrosion resistance of the coating. The more corrosion resistant coating, the longer the period in testing without showing signs of corrosion. The weathering resistance was tested as per QUV 313 with exposure conditions as condensation 45±1° C./4 hrs, UV 50±1° C./4 hrs at 0.55±0.01 watts/m²/nm irradiance level as per ASTM G154.

The coating compositions prepared using siliconized-urethane alkyd of the present invention tested for drying, physical, mechanical, weathering and corrosion resistance performance as stated above, and test results are summarized in the following table.

TABLE
Coating Composition Test Results

| Coating | | | | | | | | | |
|---|---|---|---|---|---|---|---|---|---|
| composition | | | | | | | | | |
| with Resin | Example | Example | Example | Example | Example | Example | Example | Example | Example |
| from | 1 | 2 | 3 | 4 | 5 | 6 | 7 | 8 | 9 |
| DFT (microns) | 77 | 72 | 76 | 77 | 78 | 70 | 75 | 76 | 75 |
| Surface dry time | 85 | 90 | 115 | 80 | 85 | 90 | 80 | 80 | 120 |
| (min)-IS 101 | | | | | | | | | |
| Tack free time | 4 | 4 | 4.5 | 3.5 | 4 | 4 | 3.5 | 3 | 4.5 |
| (hours)-IS 101 | | | | | | | | | |
| Hard dry time | 9 | 10 | 16 | 10 | 9 | 9 | 7 | 7 | 12 |
| (hours)-IS 101 | | | | | | | | | |
| Scratch | 1000 | 1100 | 1100 | 1000 | 1100 | 1000 | 1200 | 1200 | 1100 |
| hardness after | | | | | | | | | |
| 48 h (g) [IS 101] | | | | | | | | | |
| Flexibility-¼ | Passes | Passes | Passes | Passes | Passes | Passes | Passes | Passes | Passes |
| inch mandrel | | | | | | | | | |
| (IS 101) | | | | | | | | | |
| Impact | Passes | Passes | Passes | Passes | Passes | Passes | Passes | Passes | Passes |
| Resistance (1 Kg | | | | | | | | | |
| Front & Reverse | | | | | | | | | |
| (ISO 6172) | | | | | | | | | |
| Cross Cut | 5B | 5B | 5B | 5B | 5B | 5B | 5B | 5B | 5B |
| Adhesion | | | | | | | | | |
| (ASTM D | | | | | | | | | |
| 359B) | | | | | | | | | |
| Salt Spray Test | Passes | Passes | Passes | Passes | Passes | Passes | Passes | Passes | Passes |
| (Hours) | 600 | 550 | 400 | 500 | 1000 | 1000 | 1200 | 1200 | 1100 |
| (ASTM B117) | | | | | | | | | |
| At DFT 75-90 | | | | | | | | | |
| micron/3 coats | | | | | | | | | |
| (no under film | | | | | | | | | |
| corrosion) | | | | | | | | | |
| Gloss at 20° | 75 | 72 | 77 | 75 | 68 | 70 | 72 | 74 | 78 |
| QUB 313 Gloss | 18 | 22 | 15 | 18 | 29 | 27 | 32 | 35 | 30 |
| Retention (%) | | | | | | | | | |
| after 500 hrs | | | | | | | | | |
| Non Yellowing | Inferior | Good | Good | Poor | Good | Good | Good | Good | Good |
| after 500 hrs in | | | | | | | | | |
| QUV313, visual | | | | | | | | | |

It is thus possible, by way of the present advancement, to provide for a polymeric binder, i.e., siliconized-urethane alkyd suitable for ready-to-use single component air drying top coat/self-priming weatherable glossy enamel for mild steel substrates for low to high corrosion zones as validated through accelerated weathering in QUV 313 and accelerated corrosion resistance performance through ASTM B 117 salt fog test. Apart from excellent corrosion and weathering resistance, the said binder provided good gloss and mechanical properties like hardness, flexibility, impact and adhesion when used in a paint recipe involving organic/inorganic pigment, anticorrosive pigments, metallic driers, UV light absorbers, hindered amine light stabilizers and other additives known in the art.

Surprisingly, the coating compositions as described above, based upon a siliconized-urethane alkyd binder of the present invention, inhibited further corrosion to corroded steel when panels having 75-90 micron dry-film thickness were subjected to salt spray resistance as per ASTM B 117 and passed for 1000 hours without any sign of loss of adhesion.

The formulation and process of manufacture of said siliconized-urethane alkyd resin is selective favoring grafting of organosilanes followed by urethanization employing polyisocyanates and their derivatives in situ and in a manner to achieve a stable polymer when subjected to accelerated stability test at 55° C. for 15 days.

Most advantageously, the said siliconized-urethane alkyd provided significantly superior corrosion and weathering resistance over conventionally available alkyds or known modified alkyds while also having mineral turpentine Oil (MTO) solubility that is widely preferred for air drying alkyds or coatings derived thereof. Such siliconized-urethane alkyds find application in preparing anti-corrosive and weatherable coating compositions for protecting and maintaining the mild steel, corroded steel and other metallic substrates across the decorative and industrial segments. However, such coatings would also find application on other substrates including wood, glass and cementitious, etc.

What is claimed:

1. A siliconized-urethane alkyd resin composition comprising:
a) a base alkyd resin component having a hydroxyl number in the range of 50-150 mg KOH/gm, and an acid number in the range of 6-10 mg KOH/gm; wherein the base alkyd resin component is a reaction product of reactive sub-components selected from the groups consisting of polyhydric alcohols, polybasic carboxylic acids, polybasic anhydrides, hydroxycarboxylic acids, monofunctional carboxylic acids and vegetable oils or their fatty acids, wherein the base alkyd resin has a molecular weight in the range of 4000-8000;
b) an organosilane component comprising one or more organosilanes having epoxide functional silane to form a functionalized alkyl base resin, wherein the functionalized alkyl base resin has a molecular weight in the range of 8000-15000; and
c) an isocyanate component comprising one or more aliphatic, cycloaliphatic and aromatic isocyanate compounds having isocyanate functionality of one or more, wherein the isocyanate component consumes 40 to 70% of OH number of the base alkyd resin component, wherein the siliconized-urethane alkyd has a molecular weight in the range of 20000-35000.

2. The siliconized-urethane alkyd resin as claimed in claim 1, wherein the base alkyd component comprises one or more of:
a) vegetable oils or their fatty acids having iodine number of 120-170 gm I₂/100 g and are selected from Soy bean oil, sunflower oil, dehydrated castor oil, safflower oil, tobacco seed oil, tung oil, linseed oil, rubber seed oil, niger seed oil, perilla oil, hemp seed oil, tall oil and a mixture thereof, and the amount of the oils/fatty acids is in the range from 25 to 80% based on the alkyd resin solids;
b) polyhydric alcohols are selected from the group consisting of trimethyl pentanediol, diethylene glycol, neopentyl glycol, glycerol, pentaerythritol, trimethylolethane, trimethylol propane, methane propane diol, butyl ethyl propane diol, cyclohexane dimethylol; 1,6 hexane diol; 1,4 butane diol, sorbitol, dimethylol propionic acid and a mixture thereof, the amount of the polyols is in the range from 8 to 35% based on the alkyd resin solids;
c) polybasic acids or acid anhydrides are selected from the group consisting of isophthalic acid, terephthalic acid, phthalic anhydride, trimellitic anhydride; 1, 4 cyclohexane dicarboxylic acid; 1,2 cyclohexane dicarboxylic acid anhydride, maleopimaric acid, and dimer fatty acid, the amount of the polybasic acids or their anhydride is in the range of 8 to 35% of alkyd resin solids;
d) mono functional carboxylic acid is selected from the group consisting of benzoic acid, tertiary butyl benzoic acid, abietic acid (Rosin), and cyclohexane carboxylic acid, the amount of the mono carboxylic acid is in the range of from 0 to 15% of base alkyd composition;
e) a catalyst is selected from the group consisting of dibutyl tin oxide, lithium hydroxide, and lithium/tin salts of fatty acids/carboxylic acids in an amount of 0-0.5 wt. %; and
f) a reflux solvent is selected from the group consisting of isomers of xylene or their mixture, methyl n-amyl ketone in an amount having a range from 1 to 7 wt. %.

3. The siliconized-urethane alkyd resin as claimed in claim 1, wherein the organosilane component comprises an epoxide functional alkyl alkoxy silane is present in an amount of 0.5-5 wt % of base alkyd resin solids and are selected from the group consisting of [3-(2,3-Epoxypropoxy)propyl]trimethoxysilane]; and [3,4 epoxycyclohexyl trimethoxy silane].

4. The siliconized-urethane alkyd resin as claimed in claim 1, wherein an amount of the isocyanate component comprising:
a) the aliphatic, cycloaliphatic and aromatic mono/polyisocyanate components is present in an amount having a range of 1-10 wt. % on siliconized alkyd solids and wherein the isocyanate is selected from the group consisting of isophorone diisocyanate, hexamethylene diisocyanate, toluene diisocyanate, diphenyl methane diisocyanate and similar or their derivatives; and
b) the catalyst is present in an amount having a range of 0-0.5 wt. % as metal content on resin solids and is selected from the group consisting of compounds of metal salts or esters of tin, Zinc, Zirconium, calcium, lithium etc. such as dibutyl tin dilaurate, zinc octoate, and zirconium octoate.

5. A process for synthesizing siliconized-urethane alkyd resin composition comprising the steps of:
a) reacting one or more polyhydric alcohols with one or more polybasic acids/acid anhydrides, hydroxycarboxylic acids and monofunctional carboxylic acids along with oils/fatty acids in presence of a catalyst and reflux solvent at a reaction temperature of 170-250° C. till acid number of 6-10 mg KOH/gm is achieved, to produce the base alkyd resin component with OH number in the range of 50-150 mg KOH/gm;
b) heating said base alkyd component with organosilane component to a temperature range of 130-220° C. till an acid number of 1-5 mg/KOH is achieved, followed by distilling out methanol/water reaction condensates generated during siliconization reaction and diluting to 40-90% non-volatiles with a solvent, wherein the solvent is selected from the group of isomers of xylene and mineral turpentine oil to deliver a siliconized alkyd; and
c) reacting said siliconized alkyd through its free hydroxyls with any one of aliphatic, cycloaliphatic and aromatic polyisocyanates or their derivatives at a temperature of 50-130° C., in presence of a catalyst providing siliconized-urethane alkyds having nonvolatile content of 40-90%, wherein the process is carried out in situ in a single pot.

6. The process as claimed in claim 5 essentially consist of:
a) obtaining the base alkyd component by condensing 25-80 wt. % vegetable Oils or their fatty acids having Iodine number of 120-170 (gm I₂/100 gm) with 8-35 wt. % Polyhydric alcohols, 8-35 wt. % Poly carboxylic acids/acid anhydride, 0-15 wt. % mono carboxylic acid, 0-0.5 wt. % esterification catalyst and 1-6 wt. % reflux solvent upon heating to a temperature of 170-250° C. till acid number of 6-10 mg KOH/gm and desired viscosity is achieved;
b) reacting 80-99.5 wt. % of the base alkyd component with 0.5-10 wt. % epoxy-alkyl-alkoxy silane at 130-220° C. till an acid number of 1-5 mg KOH/gm and desired viscosity is achieved followed by distilling out the reaction condensate and diluting with solvent to obtain siliconized alkyd having non-volatile content of 40-90%;
c) incorporating the siliconized alkyd of step (b) with a catalyst selected from the group consisting of metal hydroxide, metal oxide, and metal carboxylate ester, wherein an amount of the catalyst is in the range of 0.05-0.5 wt. % as metal content on resin solids; and
d) reacting 90-99 wt % of the siliconized alkyd with any one of the aliphatic, cycloaliphatic and aromatic polyisocyanates having an amount in the range of 1-10 wt. % at a temperature of 50-130° C. till constant viscosity is achieved with the siliconized-urethane alkyd having nonvolatile content of 40-90%.

7. A method of producing air drying single component corrosion and weather resistant coating compositions from the siliconized-urethane alkyd composition recited in claim 1 comprising:
a) incorporating said siliconized-urethane alkyd with other coating ingredients selected from the group consisting of Inorganic pigments, organic pigments, anticorrosive pigments, dispersing agents, rheological additive and allowing them to disperse in a milling equipment in presence of grinding media to obtain a mill base having finish 7 on Hegmann Gauge;
b) adding remaining ingredients selected from metallic driers, UV light absorbers, hindered amine light stabilizers, anti-skin agent, additives and thinning solvents to the said mill base and allow the coating composition to mature for 16-24 hours and adjust to desired viscosity and solids; and
c) applying said coating composition on a substrate wherein the substrate is selected from a group consisting of mild steel, suitably cleaned corroded steel, other metals and their alloys and glass, wood, cementitious.

8. The method as claimed in claim 1, wherein the coating compositions are produced by using combination of metal salts of Cobalt, Zirconium, Calcium and Iron complex (Borchi Oxy Coat) or similar metal salts as driers to catalyze autoxidative cross-linking through double bonds imparting improved drying and hardness development thereby faster recoat time of about 4-8 hours to complete the painting in a shorter period.

9. The method as claimed in claim 1, wherein the coating compositions comprising of siliconized-urethane alkyd to provide superior adhesion without the need of incorporating organosilane or any other adhesion promoter into the said coating compositions.

10. The method as claimed in claim 1, wherein the coating compositions having air drying, corrosion and weather resistant coating consisting of siliconized-urethane alkyd as a polymeric binder in combination with coating ingredients suitable for “one pack” self-priming enamels, top coats, under coats and primer for a ready-to-use composition for application on variety of substrates.

11. The method as claimed in claim 1, wherein is adaptable in application process selected from brush, spray, roller, ragging and draw dawn to deposit a dry film thickness in the range of 75-90 microns in 3 or more coats with time interval of about 4-8 hours between the coats depending on the ambient temperature and humidity levels of the surroundings at the time of painting.

12. The method as claimed in claim 1, wherein the coating compositions provide aesthetics and protection to variety of substrates in a single component ready-to-use air drying paint.

13. The method as claimed in claim 1, wherein the coating compositions comprising of siliconized-urethane alkyd provide single component oxidative crosslinking through air along with excellent solubility in an economical and safer Mineral Turpentine Oil or similar hydrocarbon solvent.

14. The method as claimed in claim 1, wherein the coating compositions wherein the grafting of organosilane into alkyd backbone followed by urethanization resulted into siloxane and urethane linkages in the siliconized-urethane alkyd as claimed in any one of the preceding claims thereby providing superior mechanical, weathering and corrosion resistant performance to the coatings.

15. The method as claimed in claim 1, wherein the coating compositions comprising of said siliconized-urethane alkyd in combination with other coating ingredients provide corrosion protection in different geographical and climatic conditions including in coastal, non-coastal, rural, and urban areas.

16. The method as claimed in claim 1, wherein the coating compositions provide high gloss, corrosion resistance, mechanical properties, and weathering performance especially in respect of gloss retention and non-yellowing.

17. The method as claimed in claim 1, wherein the coating compositions when applied at dry film thickness of 75-90 microns in 3 or more coats provide salt spray resistance of 1000 hours or more as per ASTM B 117 without any sign of under film corrosion.

18. The method as claimed in claim 1, wherein the coating compositions inhibited further corrosion when applied at dry film thickness of 75-90 microns in 3 or more coats on hand tool cleaned corroded mild steel substrates and provided protection for 1000 hours or more as per ASTM B 117 Salt spray test without any sign of loss of adhesion of the film.

19. The method as claimed in claim 1, wherein a self-priming enamel and top coat based on coating compositions provide 25-35% gloss of the original gloss of the panel after 500 hours exposure test as per QUV 313 with exposure conditions as condensation 45±1° C./4 hrs, UV 50±1° C./4 hrs at 0.55±0.01 watts/m²/nm irradiance level as per ASTM G154.
